(19) United States
(12) Patent Application Publication
(10) Pub. No.: US 2012/0283370 A1
(43) Pub. Date: Nov. 8, 2012

(54) MOISTURE-CURABLE HOT MELT ADHESIVE

(75) Inventors: Tsuyoshi Tamogami, Osaka (JP); Yoshio Yoshida, Kyoto City (JP)

(73) Assignee: Henkel Corporation, Rocky Hill, CT (US)

(21) Appl. No.: 13/483,788

(22) Filed: May 30, 2012

Related U.S. Application Data
(63) Continuation of application No. PCT/US2010/058522, filed on Dec. 1, 2010.

(30) Foreign Application Priority Data
Dec. 1, 2009 (JP) 2009-273378

(51) Int. Cl. C09J 133/10

(52) U.S. Cl. 524/272

(57) ABSTRACT

The present invention provides a method for producing a moisture-curable hot melt adhesive. This moisture-curable hot melt adhesive is environmentally friendly, is compatible with the components therein, has high initial adhesion strength, has long open time and has high heat resistance after moisture curing. The moisture-curable hot melt adhesive comprises a (A) urethane prepolymer having an isocyanate group at the terminus, comprising, a (A) urethane-modified rosin, and a (B) copolymer of ethylene and a (meth)acrylic acid derivative, wherein the urethane prepolymer is obtained by the reaction of polyol with an isocyanate compound.

### FIELD OF THE INVENTION

The present invention relates to a moisture-curable hot melt adhesive and a method of producing same.

### BACKGROUND OF THE INVENTION

Moisture-curable hot melt adhesives are used in various applications including in architectural interior decorating materials (or the building material field), electronic materials and the like. Moisture-curable hot melt adhesive is an adhesive that contains a urethane prepolymer having an isocyanate group at its terminus. It is typically applied to both of the components to be adhered (or the base material and the cladding) in a melted state, and the initial adhesion occurs by cooling and solidification. Thereafter, the isocyanate groups are cross-linked by the moisture in the atmosphere, and the adhesive strength, heat resistance and the like, are improved by moisture-curing which converts the urethane prepolymer to a polymer.

One of the required performances of a moisture-curable hot melt adhesive is good initial adhesive strength. Various methods are known to increase the initial adhesive strength, including: mixing in a viscosity-enhancing resin into the moisture-curable hot melt adhesive to increase the initial wetting, mixing in a thermoplastic resin to increase the initial cohesive force, and the like. However, viscosity-enhancing resins or thermoplastic resins do not necessarily have sufficient compatibility with the urethane prepolymer which is the main component of moisture-curable hot melt adhesive.

Japanese Patent Application Publication Number JP H6-4840 discloses a polyurethane-hot melt adhesive composition that contains no viscosity-enhancing resin or plasticizer, but does contain urethane polymer and a low-molecular-weight polymer of (meth)acrylate ester, which is a heat-plasticized resin. While the initial cohesive force is increased by including the low-molecular-weight polymer, the initial wetting of the adhesive is insufficient and the initial adhesive strength is also reduced because it does not contain a viscosity-enhancing resin.

Japanese Patent Application Publication Number JP 2003-515637 discloses a urethane hot melt adhesive that contains an isocyanate compounds, a polyester polyol compounds, a heat-plasticized resin and a reactive viscosity-enhancing resin that is reactive to isocyanate compounds. However, the urethane hot melt adhesive according to JP 2003-515637 has insufficient resistance to heat, and thus, excess amount of isocyanate compound is added to remediate the heat resistance. In recent years, it has become preferable to decrease the amounts of isocyanate compounds due to environmental concerns.

The adhesives according to JP H6-4840 and JP 2003-515637 have improved initial adhesive strengths, but they have short open times. Adhesives with short open times start to cure soon after opening, and thus, they are not suitable for manually applying the adhesive onto a complex-shaped cladding.

Thus, there is desire for a moisture-curable hot melt adhesive with a superior balance of environmental friendliness, compatibility of components (uniformity of the adhesive without separation of the adhesive into layers), initial adhesive strength, open time, heat resistance after moisture curing and the like

### BRIEF SUMMARY OF THE INVENTION

The object of the invention is to provide a moisture-curable hot melt adhesive with a superior balance of environmental friendliness, compatibility of components, initial adhesive strength, open time, heat resistance after moisture curing and the like.

### DETAILED DESCRIPTION OF THE INVENTION

The present invention provides a moisture-curable hot melt adhesive and a method for preparing same. The moisture-curable hot melt adhesive according to the present invention may be used in fields such as exterior materials and interior materials for architectural materials, floorings, gluing cosmetic sheeting to base materials and profile lapping and the like.

Surprisingly, it has been discovered that the specific combinations of viscosity-enhancing resins and specific heat-plasticized resins, even without using excess isocyanate compounds, can result in an a moisture-curable hot melt adhesive with a superior balance of environmental friendliness, compatibility of components, initial adhesive strength, open time, heat resistance after moisture curing and the like.

The first aspect of the invention provides a moisture-curable hot melt adhesive containing a urethane prepolymer having an isocyanate group at the terminus, comprising:

a (A) urethane-modified rosin, and

a (B) copolymer of ethylene and a (meth)acrylic acid derivative,

wherein the urethane prepolymer is obtained by the reaction of polyol with an isocyanate compound.

In one aspect, the invention provides a moisture-curable hot melt adhesive wherein the (B) copolymer of ethylene and a (meth)acrylic acid derivative contains an ethylene-(meth)acrylic acid ester copolymer.

In another aspect, the invention provides a moisture-curable hot melt adhesive, wherein the (B) copolymer contains ethylene-methyl methacrylate copolymer and/or ethylene-n-butyl acrylate.

In a preferred embodiment, the moisture-curable hot melt adhesive comprises a urethane prepolymer which is obtained by the reaction of polyol with an isocyanate compound, and the polyol contains an aromatic polyester polyol.

Another aspect of the invention provides a method for producing a moisture-curable hot melt adhesive, which comprises:

a step (i) reacting an isocyanate compound with a rosin derivative having a hydroxyl group to obtain (A) a urethane-modified rosin, and

a step (ii) of mixing (1) the (A) urethane-modified rosin, (2) a (B) copolymer of ethylene and a (meth)acrylic acid derivative, (3) polyol and (4) an isocyanate compound.

The term “open time” is defined as the time which one starts to apply the melted moisture-curable hot melt adhesive to the cladding, until the adhesive loses fluidity and can no longer wet the surface of the cladding.

The term “initial adhesive strength” is defined as the adhesive strength after the moisture-curable hot melt adhesive is melted and applied to the cladding, and the adhesive cools and solidifies. The initial adhesive strength affects wettability and the cohesive force. The initial adhesive strength is preferably as high as possible.

The term “wettability” can be measured as the magnitude of the angle (α) formed by the tip of melted adhesive in contact with a base material (solid) when heated and the melted moisture-curable hot melt adhesive is put in contact with the base material. The smaller the angle α becomes, the greater the wettability and ease of adhesion.

The term “cohesive force” refers to the force arising from interactions between molecules in the adhesive in the process of cooling after applying the heated (and melted) moisture-curable hot melt adhesive with an applicator.

The term “final adhesive strength” is defined to be the adhesive strength achieved after the melted moisture-curable hot melt adhesive solidifies and the isocyanate groups within the adhesive react with moisture in the atmosphere to cure, or namely the adhesive strength after moisture-curing. The final adhesive strength is preferably as high as possible.

The moisture-curable hot melt adhesive is a moisture-curable hot melt adhesive containing a urethane prepolymer having an isocyanate group at the terminus, comprising:

a (A) urethane-modified rosin as a viscosity-enhancing resin, and

a (B) copolymer of ethylene and a (meth)acrylic acid derivative as a heat-plasticized resin,

wherein the urethane prepolymer is obtained by the reaction of polyol with an isocyanate compound. This moisture-curable hot melt adhesive has a superior balance of environmental friendliness, compatibility, initial adhesive strength, open time, heat resistance after moisture curing and the like.

The moisture-curable hot melt adhesive of the present invention contains a (A) urethane-modified rosin as the specific viscosity-enhancing resin and a (B) copolymer as the specific heat-plasticized resin, and can be produced without using excess isocyanate compounds. Thus the adhesive has a superior balance of environmental friendliness, compatibility, heat resistance after moisture curing, initial adhesive strength, open time and the like.

Manually applying the moisture-curable hot melt adhesive with a long open time allows the worker sufficient time to glue the cladding (e.g., films, cosmetic sheets and plastics, etc.) to the base material (e.g., wood-based materials and plastics, etc.) to form laminated components, without rush and thus, the resultant articles have cleaner bondlines and allows more complex work to be performed.

When copolymer (B) contains ethylene-(meth)acrylic ester copolymer in the moisture-curable hot melt adhesive, there is a superior balance of the compatibility, initial adhesive strength, open time and heat resistance after moisture curing.

When copolymer (B) contains ethylene-methyl methacrylate copolymer and/or ethylene-n-butyl acrylate, there is an even more superior balance of the initial adhesive strength, open time and heat resistance after moisture curing.

The urethane prepolymer of the moisture-curable adhesive is obtained by the reaction of polyol with an isocyanate compound, and this polyol contains an aromatic polyester polyol which has at least one aromatic ring. Because of the presence of the aromatic ring, the moisture-curable hot melt adhesive has increased initial adhesive strength, the open time becomes longer and it can be applied more easily by the workers for complex attachments.

The moisture-curable hot melt adhesive is obtained by mixing a (A) urethane-modified rosin, with a (B) copolymer of ethylene and a (meth)acrylic acid derivative. The mixture is essentially free of excess isocyanate compound, and thus, the heat resistance is superior.

The method for producing a moisture-curable hot melt adhesive according to the present invention comprises:

(i) reacting an isocyanate compound with a rosin derivative having a hydroxyl group to obtain (A) a urethane-modified rosin, and

(ii) mixing the (A) urethane-modified rosin with a (B) copolymer of ethylene and a (meth)acrylic acid derivative.

In one embodiment, a polyol and isocyanate compound are further added and mixed in step (ii).

The (A) urethane-modified rosin does not substantially contribute to the reaction of the polyol and isocyanate compound, and thus it is possible to increase the heat resistance after moisture curing the moisture-curable hot melt adhesive without using excess isocyanate compound.

Because excess isocyanate compound is not necessary for the above reaction, this method is environmental friendly. The moisture-curable hot melt adhesive thus obtained has a superior balance of environmental friendliness, compatibility, heat resistance after moisture curing, initial adhesive strength, open time and the like. It is preferable for the open time to be increased and the initial cohesive force becomes greater to allow for manual application and superior initial adhesion force.

By producing a moisture-curable hot melt adhesive which comprises a step of mixing polyol with an isocyanate compound in the step (ii), the isocyanate compound reacts efficiently with the polyol to obtain the urethane polymer. Accordingly, the amount of isocyanate remaining is decreased, and thus the moisture-curable hot melt adhesive is environmentally friendlier and heat resistance is improved without using excess isocyanate compound in the reaction.

The moisture-curable hot melt adhesive is constituted by containing “a urethane prepolymer having an isocyanate group at the terminus.”

The “urethane prepolymer having an isocyanate group at the end” is understood to be a “urethane prepolymer” and it is “one having an isocyanate group at the terminus.” There is no particular limitation, so long as it is possible to obtain the intended moisture-curable hot melt adhesive. Such a urethane prepolymer is obtained by reacting a polyol and an isocyanate compound in accordance with known conventional methods. The “urethane prepolymer having an isocyanate group at the terminus” may also be interchangeably called a “urethane prepolymer.”

The “polyol” is not particularly limited so long as it is possible to obtain the intended urethane prepolymer, and known polyol used in the ordinary production of polyurethane may be used as the polyol. Polyol that have 1-3 functional groups are preferable, and the so-called “diols” which are bifunctional polyols are particularly preferable. A single polyol may be used or a combination of polyols may also be used. Examples of diols include: ethylene glycol, 1-methyl ethylene glycol, 1-ethyl ethylene glycol, propylene glycol, butanediol, pentanediol, hexanediol, heptanediol, octanediol, nonanediol, decanediol, neopentyl glycol, 2-methyl-1,3-propanediol, cyclohexane dimethanol, 2,4-dimethyl-1,5-pentanediol and other low-molecular-weight diols. At least one species selected from the group consisting of ethylene glycol, butanediol, hexanediol, octanediol and decanediol is preferable. A single diol may be used or a combination of these diols may also be used.

In the present invention, the “polyol” used may be polyether polyol, polyester polyol and the like.

Included in the polyether polyols are, for example: polyoxytetramethylene glycol (PTMG), polyoxypropylene glycol (PPG), and polyoxyethylene glycol (PEG). Polyoxypropylene glycol is particularly preferable as the polyether polyol.

Examples of the polyester polyol in the present invention include: aliphatic polyester polyols and aromatic polyester polyols.

It is preferable to utilize an aromatic polyester polyol because the aromatic polyol increases the initial adhesion strength of the moisture-curable hot melt adhesive and also extends the open time to a certain degree.

The aromatic polyester polyol is preferably one that is obtained by the reaction of an aromatic carboxylic acid and a diol. Examples of aromatic carboxylic acids include: phthalic acid, isophthalic acid, terephthalic acid, hexahydroisophthalic acid and the like. A single type of these acids may be used or a combination of two or more types may also be used. Examples of aromatic polyester polyols include: polyalkylene phthalate, polyalkylene isophthalate and polyalkylene terephthalate. Polyalkylene phthalate is particularly preferable as the aromatic polyester polyol.

Aliphatic polyester polyols can be obtained by the reaction of an aliphatic carboxylic acid and a diol. Examples of aliphatic carboxylic acids include: adipic acid, sebacic acid, azelaic acid and decamethylene dicarboxylic acid. A single type of these acids may be used or a combination of two or more types may also be used. Examples of aliphatic polyester polyols include: poly(hexamethylene adipate) (PHMA) and poly(butylene adipate) (PBA). Poly(hexamethylene adipate) is particularly preferable as the aliphatic polyester polyol.

Accordingly, particularly preferable polyol is a mixture of polyoxypropylene glycol, polyalkylene phthalate and poly(hexamethylene adipate).

The isocyanate compound in the present invention is not particularly limited so long as it is possible to obtain the intended urethane prepolymer, thus, any known isocyanate compound used in the ordinary production of polyurethane may be used. For the isocyanate compound, those that have an average of 1-3 isocyanate groups per molecule are preferable, and the so-called diisocyanate compounds which are bifunctional isocyanate compounds are particularly preferable. A single isocyanate compound may be used or a combination of isocyanate compounds may also be used.

Examples of the “isocyanate compound” include: ethylene diisocyanate, ethylidene diisocyanate, propylene diisocyanate, butylene diisocyanate, hexamethylene diisocyanate, toluene diisocyanate, cyclopentylene-1,3-diisocyanate, cyclohexylene-1,4-diisocyanate, cyclohexylene-1,2-diisocyanate, 4,4′-diphenylmethane diisocyanate, 2,2′-diphenylpropane-4,4′-diisocyanate, p-phenylene diisocyanate, m-phenylene diisocyanate, xylylene diisocyanate, 1,4-naphthylene diisocyanate, 1,5-naphthylene diisocyanate, diphenyl-4,4′-diisocyanate, azobenzene-4,4′-diisocyanate, diphenylsulfone-4,4′-diisocyanate, dichlorohexamethylene diisocyanate, furfurylidene diisocyanate, 1-chlorobenzene-2,4-diisocyanate and the like. A single isocyanate compound may be used or a combination of these compounds may also be used.

When producing the “urethane prepolymer,” so long as the intended urethane prepolymer can be obtained, it is possible to use a monool or monoisocyanate, or a trifunctional polyol or trifunctional isocyanate, but it is preferable to use a bifunctional polyol (diol) and a bifunctional isocyanate (diisocyanate) in production. Producing the “urethane prepolymer” by reacting a bifunctional polyol and a bifunctional isocyanate is particularly preferable for the thermal stability of the moisture-curable hot melt adhesive for production method. It is preferable to combine one mole of a bifunctional polyol with two moles of a bifunctional isocyanate to produce a urethane prepolymer.

The “(A) urethane-modified rosin” is defined to be the reaction product of hydroxyl group containing rosin derivative with an isocyanate group compound. The hydroxyl group-containing rosin derivative may be obtained, for example, by the reaction of rosin and a polyvalent alcohol, e.g., a diol, whereby a carboxyl group of the rosin is bonded to one hydroxyl group of the polyvalent alcohol by an ester bond.

The (A) urethane-modified rosin has substantially no hydroxyl groups, and as a result, has substantially no reactivity with isocyanate compounds. To obtain (A) urethane-modified rosin, it is preferable that the reaction be performed such that the hydroxyl groups of the “hydroxyl group-containing rosin derivative” be equivalent to the isocyanate groups of the “isocyanate compound.”

For producing the (A) urethane-modified rosin, it is also possible to use a rosin with a weight-average molecular weight of 1000 or less.

Examples of the type of “rosin” include: gum rosin, wood rosin, tall oil rosin and other unmodified rosins, as well as asymmetrical rosins, hydrogenated rosins and polymerized rosins based on these rosins, along with purified extracts thereof. In addition, it is also possible to use maleated rosin produced by adding maleic anhydride, fumaric acid, acrylic acid and derivatives thereof.

Examples of the polyvalent alcohol include: ethylene glycol, propylene glycol, diethylene glycol, dipropylene glycol and other divalent alcohols, glycerin, trimethylolpropane and other trivalent alcohols, pentaerythritol, diglycerin and other quadrivalent alcohols, and dipentaeiythritol and other hexavalent alcohols.

Esters of rosin and polyvalent alcohol (hereinafter, also called “rosin esters”) can be obtained using known methods. For example, they can be obtained by heating rosin and alcohol in an inactive atmosphere of nitrogen gas and the like. The reaction conditions at this time are typically such that the reaction is performed at 250-280° C. for 5-20 hours.

The aforementioned method of production is applicable to formalin-modified rosin, modified rosin alcohols and the like, and is also applicable to rosin subjected to phenolation or other types of modification.

The “isocyanate compound” serving as the raw material for urethane-modified rosin may be the same as the “isocyanate compound” recited in regard to the production of the “urethane prepolymer,” or it may be different. The “isocyanate compound” serving as the raw material for urethane-modified rosin may be a monoisocyanate or a diisocyanate, so long as it has one or more isocyanate groups within the compound. It may also be an isocyanate added to the polyvalent alcohol, etc.

The “(B) copolymer of ethylene and a (meth)acrylic acid derivative,” also herein as “copolymer (B)” is defined to be a polymer formed by the copolymerization of “ethylene” and a “(meth)acrylic acid derivative.”

The “(meth)acrylic acid derivative” is defined as both methacrylic acid derivatives and acrylic acid derivatives. “Acrylic acid derivatives” mean acrylic acid and derivatives of acrylic acid. Because vinyl esters have a vinyl group bonded to oxygen, vinyl acetate are not included in the definition of (meth)acrylic acid derivatives.

In one embodiment, the copolymer (B) is a thermoplastic resin and the use of this resin in the moisture-curable hot melt adhesive increase the initial cohesive force and wetting of the cladding, thereby increasing the initial adhesion strength of the adhesive.

Specific examples of methacrylic acid derivatives include: methacrylic acid; and methyl methacrylate, ethyl methacrylate, n-propyl methacrylate, isobutyl methacrylate, isobornyl methacrylate, isopropyl methacrylate, t-butyl methacrylate, cyclohexyl methacrylate, s-butyl methacrylate and other methacrylic acid esters.

A single type of these derivatives may be used or a combination of two or more types may also be used.

The methacrylic acid esters may be aryl esters or alkyl esters, preferably, alkyl esters. The alkyl groups may have a cyclic structure (e.g., cyclohexyl, isobornyl or the like), a chain structure (e.g., methyl, ethyl, propyl or the like), linear (e.g., n-propyl, n-butyl or the like) or branched (e.g., isobutyl, t-butyl or the like), and may optionally contain substituents (e.g., methoxy groups, dimethylamino groups, trifluoromethyl groups). A particularly preferred methacrylic acid ester is a particularly preferably methyl methacrylate.

Specific examples of acrylic acid derivatives include: acrylic acid; and methyl acrylate, ethyl acrylate, n-propyl acrylate, isobutyl acrylate, n-butyl acrylate, n-propyl acrylate, isopropyl acrylate, s-butyl acrylate, t-butyl acrylate, amyl acrylate, isoamyl acrylate, n-hexyl acrylate, 2-ethylhexyl acrylate, lauryl acrylate, i-octyl acrylate, decylmethyl acrylate, stearyl acrylate, cyclohexyl acrylate, isobornyl acrylate, 2-methoxyethyl acrylate, 2-(N,N-dimethylamino)ethyl acrylate, trifluoromethyl acrylate, trimethoxysilylpropyl acrylate, dodecyl acrylate, tridecyl acrylate and other acrylic acid esters.

A single type of these derivatives may be used or a combination of two or more types may also be used.

The acrylic acid esters may be aryl esters or alkyl esters, but they are preferably alkyl esters. The alkyl groups may have a cyclic structure (e.g., cyclohexyl, isobornyl or the like), a chain structure (e.g., methyl, ethyl, propyl or the like), and may be straight-chained (e.g., n-propyl, n-butyl or the like) or branched (e.g., isobutyl, t-butyl or the like), and may or may not have substituents (e.g., methoxy, dimethylamino, trifluoromethyl or the like). The acrylic acid ester is preferably n-butyl acrylate.

To balance the compatibility, initial adhesion strength and heat resistance, the copolymer (B) of the moisture-curable hot melt adhesive preferably contains an ethylene-methyl methacrylate copolymer and/or an ethylene-n-butyl acrylate copolymer, and more preferably an ethylene-methyl methacrylate copolymer and/or an ethylene-n-butyl acrylate copolymer. A single copolymer (B) may be used or a combination thereof may also be used.

The melt index of copolymer (B) is preferably 10-500 g/10 minutes, and particularly preferably 300-500 g/minute. The “melt index” is defined to be the amount of resin that is pushed out per 10 minutes from an opening (nozzle) provided on the bottom of a cylindrical vessel when a fixed amount of synthetic resin is placed within the vessel, which is heated to a stipulated temperature and also pressurized. The value is expressed in units of g/10 minutes. It is preferable that the melt index of copolymer (B) is 10-500 g/10 minutes, because this improves the compatibility of copolymer (B) with the other components and this improves the initial adhesion strength of the moisture-curable hot melt adhesive.

The moisture-curable hot melt adhesive may also contain various additives as necessary. These “additives” are defined to be those that are typically used in moisture-curable hot melt adhesive. Examples of such additives include: plasticizers, oxidation inhibitors, pigments, light stabilizers, flame retardants and catalysts, waxes and the like.

Examples of the “plasticizers” include: dioctyl phthalate, dibutyl phthalate, dioctyl adipate, mineral spirits and the like.

Examples of the “oxidation inhibitors” include: phenol-based oxidation inhibitors, phosphite-based oxidation inhibitors, thioether-based oxidation inhibitors, amine-based oxidation inhibitors and the like.

Examples of the “pigments” include: titanium oxide, carbon black and the like.

Examples of the “light stabilizers” include: benzotriazole, hindered amine, benzoate, benzotriazole and the like.

Examples of the “flame retardants” include: halogen-based flame retardants, phosphorus-based flame retardants, antimony-based flame retardants,

Examples of the “catalysts” include: metal-based catalysts, for example, tin-based catalysts (trimethyltin laurate, trimethyltin hydroxide, dibutyltin laurate, dibutyltin maleate, etc.), lead-based catalysts (lead oleate, lead naphthenate, lead octoate, etc.) and other metal-based catalysts (cobalt naphthenate and other metal salts of naphthenic acid, etc.) and amine-based catalysts, for example, triethylene diamine, tetramethyl ethylene diamine, tetramethyl hexylene diamine, diazabicycloalkenes, dialkylaminoalkylamines and the like.

Examples of the “waxes” include: paraffin wax, microcrystalline wax and the like.

The method of the producing the aforementioned moisture-curable hot melt adhesive is not particularly limited. In one embodiment, the moisture-curable hot melt adhesive is produced using the method of:

(i) reacting an isocyanate compound with a rosin derivative having a hydroxyl group to obtain (A) a urethane-modified rosin, and

(ii) mixing the (A) urethane-modified rosin with a (B) copolymer of ethylene and a (meth)acrylic acid derivative.

The reaction between the isocyanate compound and the rosin derivative having a hydroxyl group in step (i) may be form by reacting an isocyanate compound and any general compound having a hydroxyl group. This reaction is typically performed by mixing the two components.

The “reacting” in step (i) and the “mixing” in step (ii) may be performed by any known mixing method.

Moreover, the present invention provides a moisture-curable hot melt adhesive that is produced by the aforementioned methods of production.

The moisture-curable hot melt adhesive of the invention may be used in any conventional moisture-curable hot melt adhesive application fields. Moreover, it may also be used in applications that demand a high initial adhesive strength such as exterior materials and interior materials for architectural materials, flooring, gluing cosmetic sheeting to base materials, profile lapping and the like.

The aforementioned moisture-curable hot melt adhesive is suited, but not limited, to gluing cosmetic material to floors as architectural interior materials and gluing cosmetic sheeting to other base materials. The moisture-curable hot melt adhesive may also be used for carpentry applications, wallpaper applications, fiber applications and other general uses.

The moisture-curable hot melt adhesive of the invention can also be used by in the same manner as the conventional moisture-curable hot melt adhesive and is not limited with respect to its method of usage so long as the intended members and laminates are obtained. In addition, for example, the moisture-curable hot melt adhesive may be applied to either the base material or the cladding to form a bond.

The “cladding” is not particularly limited, but specific examples include films, cosmetic sheeting and the like.

The films may be colorless or colored, transparent or opaque, and made of polyolefin resin, polyester resin, acetate resin, polystyrene resin, vinyl chloride resin and the like. Examples of polyolefin resins include polyethylene and polypropylene, while examples of polyester resins include polyethylene terephthalate.

Examples of cosmetic sheeting include the following: sheeting made of hard or semi-hard vinyl chloride resin, polyolefin resin, polyester resin and other plastic materials; wood veneer made by processing wood into sheets; and cosmetic papers produced by various types of cosmetic printing.

The “base material” may include, but not limited to, the following: lauan plywood or other plywood, medium-density fiberboard (MDF), particleboard, natural wood, wood-fiber board and other wood-based materials; cement board, gypsum board, autoclaved lightweight concrete (ALC) and other inorganic materials; and polyvinyl chloride resin, polyolefin resin, polyester resin and other plastic materials.

The laminates are obtained by gluing the cladding to the base material with the moisture-curable hot melt adhesive of the invention, and the laminates are used in various applications including, architectural materials, electronic materials, the automotive field and the like.

While specialized apparatus is not necessary, laminates may be produced by known production apparatus including conveyors, coaters, presses, heaters, cutters and the like.

For example, laminates may be produced as follows. The base material and cladding may be fed upon conveyors while the moisture-curable hot melt adhesive of the invention is applied with a coater to the base material or cladding. The temperature at the time of application is controlled to a set temperature with a heater. The cladding is lightly pressed onto the base material with a press so that the cladding is glued to the base material with the moisture-curable hot melt adhesive. Thereafter, the glued cladding and base material are allowed to cool and fed on the conveyor while the moisture-curable hot melt adhesive is hardened. Thereafter, the base material with the cladding applied is cut to the proper sizes with the cutter.

Because of the initial adhesion strength and long open time of the moisture-curable hot melt adhesive, manual application of the adhesive without the use of a coater is possible. The production method according to the present invention is particularly suited to cases in which it is necessary to apply a moisture-curable hot melt adhesive to base materials (cladding) of complex shapes or narrow widths that are difficult to carry on in production lines.

The aforementioned moisture-curable hot melt adhesive and its method of production exhibits superior meritorious effects as described above, and the reasons therefore are thought to be as follows.

While not bound to any theory, it is believed that the reaction between the polyol and isocyanate compound does not substantially affect reaction of the (A) urethane-modified rosin when mixed with the copolymer (B), because the (A) a urethane-modified rosin has substantially no hydroxide groups. By producing the urethane-modified rosin and urethane prepolymer separately, it is possible to independently control the components of each, and this is one characteristic of the invention.

Accordingly, there is no need to add excess isocyanate compound to produce the moisture-curable hot melt adhesive.

Moreover, the aforementioned moisture-curable hot melt adhesive of the invention contains both a (A) urethane-modified rosin which is a viscosity-enhancing resin, and a copolymer (B) which is a heat-plasticized resin. The resultant adhesive has a superior balance of environmental friendliness, compatibility, initial adhesive strength, open time, heat resistance after moisture curing and the like, and preferably it has superior environmental friendliness, superior compatibility of components, superior heat resistance after moisture curing, and also has a superior initial adhesive strength because the initial wetting and cohesive force are higher, and the open time becomes longer.

With the production method according to the present invention, the (A) urethane-modified rosin is produced by reacting a hydroxide group-containing rosin derivative and an isocyanate compound, and then the (A) urethane-modified rosin is mixed with a copolymer (B), a polyol and an isocyanate compound. First, the hydroxyl group-containing rosin derivative is reacted with an isocyanate compound, in order for the hydroxyl groups of the hydroxyl group-containing viscosity-enhancing resin are eliminated, and this is one characteristic of the invention. Accordingly, the production method according to the present invention is different from the production method recited in JP 2003-515637 in which the reactive viscosity-enhancing resin, polyol, isocyanate compound and thermoplastic resin are mixed (or namely, reacted) at once (or in one batch).

The reactive viscosity-enhancing resin recited in JP 2003-515637 contains hydroxyl groups that can react with the isocyanate compound. These hydroxyl groups react with the isocyanate groups at the terminus of the urethane prepolymer, thus halting the progress of the chain length-elongating reaction. Because the chain length-elongating reaction is halted, the moisture-curable hot melt adhesive undergoes inadequate moisture curing, and thus, adequate heat resistance cannot be obtained. If an excess of isocyanate compound is used to solve this problem and to increase the heat resistance, then large amounts of isocyanate compound may remain in the moisture-curable hot melt adhesive. When a moisture-curable hot melt adhesive with an excess amount of isocyanate compound is heated, the excess amounts of the isocyanate compound are volatilized which is environmentally harmful. Moreover, if reactive viscosity-enhancing resin is incorporated into the urethane prepolymer, the crystallinity of the urethane prepolymer decreases, thereby, the initial cohesive force becomes delayed.

While not bound to any specific theory, it is believed that the (A) urethane-modified rosin does not participate in the urethane prepolymer-forming reaction, but rather the urethane prepolymer and the (A) urethane-modified rosin function independently in the adhesive, and thus have synergistic effects.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

### EXAMPLES

The components of the moisture-curable hot melt adhesive used in the working examples and comparative examples are given below.

### Viscosity-Enhancing Resins

(A-1) Urethane-modified rosin (its method of production is described below.)

(A′-2) Rosin ester (Super Ester A100 (trade name) made by Arakawa Chemical Industries, Ltd.: hydroxyl value 15, weight-average molecular weight 920, softening point 100° C.)

### Thermoplastic Resins

(B-1) Ethylene-methyl methacrylate copolymer (hereinafter, also called “EMMA resin”) (Acryft CM5022 (trade name) made by Sumitomo Chemical Co., Ltd.: melt index 450 g/10 minutes, methyl methacrylate content 32%)

(B-2) Ethylene-methyl methacrylate copolymer (hereinafter, also called “EMMA resin”) (Acryft CM5021 (trade name) made by Sumitomo Chemical Co., Ltd.: melt index 450 g/10 minutes, methyl methacrylate content 28%)

(B-3) Ethylene-n-butyl acrylate copolymer (hereinafter, also called “EnBA resin”) (Enable EN33330 (trade name) made by ExxonMobil Chemical: melt index 330 g/10 minutes, n-butyl acrylate content 33.5%)

(B′-4) Ethylene-vinyl acetate copolymer (hereinafter, also called “EVA resin”) (Ultrasen 726 (trade name) made by Tosoh Corp.: melt index 700 g/10 minutes, vinyl acetate content 31%)

(B′-5) Methyl methacrylate-acrylic acid-butyl acrylate copolymer (Dianal BR113 (trade name) made by Mitsubishi Rayon Co., Ltd.)

(B′-6) Olefin (ethylene/propylene/1-butylene) copolymer (Vestoplast 728 (trade name) made by Evonik Degussa GmbH)

### Polyols

(C-1) Aliphatic polyester polyol (HS 2H-351A (trade name) made by Hokoku Corporation, produced using adipic acid and 1,6-hexanediol: hydroxyl value 32, melting point 55° C., crystalline)

(C-2) Aliphatic polyester polyol (HS 2H-231AS (trade name) made by Hokoku Corporation, produced using adipic acid, neopentyl glycol and 1,6-hexanediol: hydroxyl value 56, amorphous)

(C-3) Aromatic polyester polyol (HS 2F-136P (trade name) made by Hokoku Corporation, produced using phthalic acid and neopentyl glycol: hydroxyl value 110, glass transition point 27° C., amorphous)

(C-4) Aromatic polyester polyol (HS 2F-306P (trade name) made by Hokoku Corporation, produced using phthalic acid and neopentyl glycol: hydroxyl value 37, glass transition point 27° C., amorphous)

(C-5) Aromatic polyester polyol (HS 2H-458T (trade name) made by Hokoku Corporation, produced using terephthalic acid and 1,6-hexanediol: hydroxyl value 37, glass transition point 27° C., amorphous)

(C-6) Aromatic polyester polyol (HS 2H-359T (trade name) made by Hokoku Corporation, produced using terephthalic acid and 1,6-hexanediol: hydroxyl value 32, melting point 110° C., crystalline)

(C-7) Aliphatic polyester polyol (polyoxypropylene glycol; Hiflex D2000 (trade name) made by Dai-ichi Kogyo Seiyaku Co., Ltd.)

### Isocyanate Compound

(D) 4,4′-Diphenylmethane diisocyanate (hereinafter, also called “MDI”) (Millionate MT (trade name) made by Nippon Polyurethane Industry Co., Ltd.)

The aforementioned components in the proportions are indicated in Table 1 and Table 2. The moisture-curable hot melt adhesives of Working Examples 1-8 and Comparative Examples 1-7, were prepared and their performances were evaluated. The following is a description of the method of making the moisture-curable hot melt adhesives and the method of evaluating them.

### Production of Urethane-Modified Rosin

Into a reaction vessel, 90 parts by weight of rosin ester (A′-2) was placed in a reaction vessel and melted in a 120° C. oven, and then the reaction vessel was heated in a 120° C. oil bath and stirred for 1 hour in a vacuum to eliminate moisture.

Next, at the same temperature, 3.3 parts by weight of MDI (D) was added and mixed for 2 hours in a vacuum at the same temperature to obtain urethane-modified rosin (A-1).

The molecular weight distribution of the urethane-modified rosin (A-1) was measured using a gel permeation chromatography analysis (GPC analysis) and the result confirmed that the molecular weight of the urethane-modified rosin (A-1) was approximately twice the molecular weight of the rosin ester (A′-2). In addition, the infrared spectrographic analysis (IR analysis) confirmed that the absorption by isocyanate groups at 2300 cm⁻¹ was nearly eliminated.

### Production of Moisture-Curable Hot Melt Adhesive

### Working Example 1

As shown in Table 1, 27.5 parts by weight of urethane-modified rosin (A-1) and 14.0 parts by weight of EMMA resin (B-1) were placed in a reaction vessel and then heated at 120° C., 21.0 parts by weight of polyol (C-1), 11.6 parts by weight of polyol (C-3), 4.7 parts by weight of polyol (C-5), 4.7 parts by weight of polyol (C-6), and 8.4 parts by weight of polyol (C-7) were added and stirred for 1 hour in a vacuum to eliminate moisture. Next, 14.1 parts by weight of MDI (D) was added and stirred for 2 hours under vacuum to obtain a moisture-curable hot melt adhesive.

### Working Examples 2-7

The moisture-curable hot melt adhesive was prepared with the components set forth in Table 1. The method of making the adhesive was the same as in Working Example 1.

In Working Example 2, the EMMA resin (B-2) was used instead of the EMMA resin (B-1) of Working Example 1.

In Working Example 3, the EnBA resin (B-4) was used instead of the EMMA resin (B-1) of Working Example 1.

In Working Examples 5 and 6, the polyol (C-4) was added.

In Working Example 7, the polyol (C-2) was added.

### Comparative Example 1

Rosin ester (A′-2) was added in Comparative Example 1 instead of the urethane-modified rosin (A-1) used in Working Example 1.

### Comparative Examples 2-6

In Comparative Examples 2-4, the EVA resin (B′-4), the methyl methacrylate-acrylic acid-butyl acrylate copolymer (B′-5), and the olefin copolymer (B′-6) were used instead of the EMMA resin (B-1) used in Working Example 1.

In Comparative Example 5, the urethane-modified rosin (A-1) was not used.

In Comparative Example 7, the EMMA resin (B-1) was not used.

### Working Example 8, Comparative Example 7

While the urethane-modified rosin (A-1) was not used, rosin ester (A′-2) was mixed with the isocyanate compound to produce urethane-modified rosin, thus essentially using the urethane-modified rosin. This is provided, however, that in Working Example 8 and Comparative Example 7, the mixing method (mixing order) of the rosin ester (A′-2) and the isocyanate compound was different; in Working Example 8, a portion of the isocyanate compound was reacted in advance with the rosin ester (A′-2) and then the isocyanate compound was reacted with polyol. The composition of the various components is indicated in Table 2. Details of the production of the moisture-curable hot melt adhesives according to Working Example 8 and Comparative Example 7 are as follows.

### Working Example 8

21.0 parts by weight of rosin ester (A′-2) and 14.0 parts by weight of EMMA resin (B-2) were placed in a reaction vessel and melted in a 120° C. oven, and then the reaction vessel was heated in a 120° C. oil bath and stirred for 1 hour in a vacuum to eliminate moisture. At the same temperature, 0.74 parts by weight of MDI (D) was added and stirred for 2 hours under vacuum. Next, at the same temperature, 21.0 parts by weight of polyol (C-1), 11.6 parts by weight of polyol (C-3), 4.7 parts by weight of polyol (C-5), 4.7 parts by weight of polyol (C-6), and 8.4 parts by weight of polyol (C-7) were added and stirred for 1 hour in a vacuum to eliminate moisture. Next, at the same temperature, 14.1 parts by weight of MDI (D) was added and stirred for 2 hours under vacuum to obtain a moisture-curable hot melt adhesive.

### Comparative Example 7

In the same manner as in Working Example 8, rosin ester (A′-2) and EMMA resin (B-2) were placed in a reaction vessel. Next, the polyols (C-1), (C-3), (C-4), (C-5), (C-6) and (C-7) were added to the reaction vessel in the composition indicated in Table 2. Then, MDI (D) was added to obtain a moisture-curable hot melt adhesive.

### Testing Method

### Compatibility

The solubility of the various components of the moisture-curable hot melt adhesive was examined to determine whether a phase separation occurred in the moisture-curable hot melt adhesive.

First, each sample was placed in a vessel, left open for 1 hour in a 120° C. oven and visually observed to determine whether a phase separation occurred.

Next, each moisture-curable hot melt adhesive sample was applied to a transparent base material of PET, and dried it for 1 hour at 20° C. to produce a film with a thickness of 100 μm. The uniformity of the film was visually observed. The criteria for evaluation are presented below.

There is no phase separation in the adhesive and the film is uniform: ◯

There is no phase separation in the adhesive but the film is not uniform: Δ

There is phase separation in the adhesive and the film is not uniform: x

### Open Time

A MDF board was coated with 40 g/m2 of the moisture-curable hot melt adhesives from the various working examples and comparative examples. After coating, small pieces of readily-adhered sheeting at regular time intervals was attached. The time when the MDF board could no longer hold the small pieces was determined as the open time. The criteria for the evaluation of the open time are as follows. Actual times are reported in the Table.

Open time is 30 minutes or greater: ◯

Open time is 5 minutes or greater and less than 30 minutes: Δ

Open time is less than 5 minutes: x

Measurement was not possible since no adhesion occurred: —

### Initial Cohesive Force

The plywood was coated with 40 g/m2 of the moisture-curable hot melt adhesives from the various working examples and comparative examples, and 2 minutes later, PET sheeting was attached to the plywood with a roll press at a pressure of 0.5 kg/cm. Then, 3 minutes later samples were cut to a size of 25 mm×100 mm to measure their 180° peel strength at a pulling speed of 200 mm/minute, thus evaluating the initial cohesive force. The criteria for the evaluation of the initial cohesive force were as follows. The actual peel strengths are recorded in the Table.

Peel strength is 30N or greater: ⊙

Peel strength is 20N or greater and less than 30N: ◯

Peel strength is 10N or greater and less than 20N: Δ

Peel strength is less than 10N: x

Measurement was not possible since no adhesion occurred: —

### Heat Resistance (100° C. Hot Water Test)

The plywood was coated with 40 g/m2 of the moisture-curable hot melt adhesives from the various working examples and comparative examples, and 2 minutes later, PET sheeting was attached to the plywood with a roll press at a pressure of 0.5 kg/cm. Then, after curing for 3 days at an environment of 23° C. and 60% RH, samples were cut to a size of 10 cm×10 cm. These samples were immersed for 4 hours in boiling water, dried for 20 hours at 60° C., again immersed for 4 hours in boiling water and then dried for 3 hours at 60° C. The PET sheeting was removed from the plywood by hand and visual appearance was recorded. The criteria for the evaluation of the heat resistance are as follows.

Material damage to the plywood occurred: ◯

The PED sheeting ruptured or separated, or cohesion ruptures (material destruction) of the adhesive occurred: x

Measurement was not possible since no adhesion occurred: —

### Heat-Resistant Adhesiveness

The samples were prepared in the same manner as the above heat resistant test. The samples were subjected to a load of 500 g after slightly peeling the PET sheeting (25 mm width), and left them for 7 days in a 70° C. dryer, and then evaluated the heat-resistant adhesiveness based on the amount of shift. The criteria for the evaluation of the heat resistance are as follows.

Amount of shift was less than 10 mm. ◯

Amount of shift was 10 mm or greater: x

Measurement was not possible since no adhesion occurred: —

TABLE 1

| | Working | Working | Working | Working | Working | Working | Working |
|---|---|---|---|---|---|---|---|
| | Example 1 | Example 2 | Example 3 | Example 4 | Example 5 | Example 6 | Example 7 |
| A-1 | 21.7 | 21.7 | 21.7 | 21.7 | 22.0 | 20.5 | 22.7 |
| A′-2 | | | | | | | |
| B-1 | 14.0 | | | 7.0 | 14.1 | 19.8 | 14.6 |
| B-2 | | 14.0 | | | | | |
| B-3 | | | 14.0 | 7.0 | | | |
| B′-4 | | | | | | | |
| B′-5 | | | | | | | |
| B′-6 | | | | | | | |
| C-1 | 21.0 | 21.0 | 21.0 | 21.0 | 21.2 | 19.8 | 31.6 |
| C-2 | | | | | | | 13.4 |
| C-3 | 11.6 | 11.6 | 11.6 | 11.6 | 13.0 | 12.1 | |
| C-4 | | | | | 9.4 | 8.8 | |
| C-5 | 4.7 | 4.7 | 4.7 | 4.7 | | | |
| C-6 | 4.7 | 4.7 | 4.7 | 4.7 | | | |
| C-7 | 8.4 | 8.4 | 8.4 | 8.4 | 7.1 | 6.6 | 7.3 |
| D | 14.1 | 14.1 | 14.1 | 14.1 | 12.4 | 12.4 | 10.4 |
| Total | 100.2 | 100.2 | 100.2 | 100.2 | 99.2 | 100.0 | 100.0 |
| Compatibility | ◯ | ◯ | ◯ | ◯ | ◯ | ◯ | ◯ |
| Open Time | ◯ | ◯ | ◯ | ◯ | ◯ | ◯ | ◯ |
| | 45 min. | 40 min. | 45 min. | 42 min. | 50 min. | 50 min. | 30 min. |
| Initial Cohesive | ⊚ | ⊚ | ◯ | ⊚ | ⊚ | ⊚ | ◯ |
| Force | 32N | 32N | 25N | 30N | 35N | 35N | 20N |
| Heat Resistance | ◯ | ◯ | ◯ | ◯ | ◯ | ◯ | ◯ |
| Heat-Resistant | ◯ | ◯ | ◯ | ◯ | ◯ | ◯ | ◯ |
| Adhesiveness | | | | | | | |

| | Compar- | Compar- | Compar- | Compar- | Compar- | Compar- |
|---|---|---|---|---|---|---|
| | ative | ative | ative | ative | ative | ative |
| | Example 1 | Example 2 | Example 3 | Example 4 | Example 5 | Example 6 |
| A-1 | | 21.7 | 21.7 | 22.0 | | 22.0 |
| A′-2 | 21.7 | | | | | |
| B-1 | 14.0 | | | | 14.0 | |
| B-2 | | | | | | |
| B-3 | | | | | | |
| B′-4 | | 14.0 | | | | |
| B′-5 | | | 14.0 | | | |
| B′-6 | | | | 14.0 | | |
| C-1 | 21.0 | 21.0 | 21.0 | 21.0 | 21.0 | 21.0 |
| C-2 | | | | | | |
| C-3 | 11.6 | 11.6 | 11.6 | 11.6 | 11.6 | 11.6 |
| C-4 | | | | | | |
| C-5 | 4.7 | 4.7 | 4.7 | 4.7 | 4.7 | 4.7 |
| C-6 | 4.7 | 4.7 | 4.7 | 4.7 | 4.7 | 4.7 |
| C-7 | 8.4 | 8.4 | 8.4 | 8.4 | 8.4 | 8.4 |
| D | 14.1 | 14.1 | 14.1 | 14.1 | 14.1 | 14.1 |
| Total | 100.2 | 100.2 | 100.2 | 100.5 | 78.5 | 86.5 |
| Compatibility | Δ | Δ | X | X | X | ◯ |
| Open Time | ◯ | ◯ | — | — | — | Δ |
| | 50 min. | 30 min. | | | | 15 min. |
| Initial Cohesive | X | ◯ | — | — | — | X |
| Force | 3N | 25N | | | | 2N |
| Heat Resistance | X | X | — | — | — | X |
| Heat-Resistant | X | X | — | — | — | X |
| Adhesiveness | | | | | | |

As shown in Table 1, the moisture-curable hot melt adhesive according to Working Examples 1-7 contain a (A) urethane-modified rosin, and a (B) copolymer of ethylene and a (meth)acrylic acid derivative. The (A) urethane-modified rosin does not substantially contribute to the reaction of the polyol and isocyanate compound, and thus, in comparison to the case in which rosin is present, the polyol (C) and the (D) MDI react efficiently. The amount of the MDI (D) remaining is decreased in the moisture-curable hot melt adhesive, and thus, it is environmentally friendly. The compatibility of copolymer (B) with the (A) urethane-modified rosin is superior, and moreover it has an effect of increasing the initial cohesive force, and extending the open time. From Table 1, it is clear that the moisture-curable hot melt adhesives according to Working Examples 1-7 have superior compatibility, longer open times, superior initial cohesive forces and heat resistances.

In contrast, the moisture-curable hot melt adhesives according to Comparative Examples 1-6 do not contain one or the other of the (A) urethane-modified rosin or the (B) copolymer of ethylene and a (meth)acrylic acid derivative. The moisture-curable hot melt adhesives according to the comparative examples resulted in poorer compatibility, open time, initial cohesive force and heat resistance than the working examples.

TABLE 2

| | Working | Comparative |
|---|---|---|
| | Example 8 | Example 7 |
| A′-2 | 21.0 | 21.7 |
| B-1 | 14.0 | 14.0 |
| B-2 | | |
| B-3 | | |
| B′-4 | | |
| B′-5 | | |
| B′-6 | | |
| D: Added before C | 0.74 | |
| C-1 | 21.0 | 21.0 |
| C-2 | | |
| C-3 | 11.6 | 11.6 |
| C-4 | | |
| C-5 | 4.7 | 4.7 |
| C-6 | 4.7 | 4.7 |
| C-7 | 8.4 | 8.4 |
| D: Added with C | 14.1 | 14.1 |
| Total | 100.2 | 100.2 |
| Compatibility | ◯ | Δ |
| Open Time | ◯ | ◯ |
| | 45 min. | 50 min. |
| Initial Cohesive Force | ⊚ | X |
| | 32N | 3N |
| Heat Resistance | ◯ | X |
| Heat-Resistant Adhesiveness | ◯ | X |

As shown in Table 2, Working Example 8 and Comparative Example 7 were both prepared by first mixing the rosin ester (A′-2) and the EMMA resin (B-1) and then the polyol (C) and MDI (D) serving as the raw material for the urethane prepolymer. However, in Working Example 8, only MDI (D) was added and reacted with the rosin ester (A′-2) to produce the urethane-modified rosin (A) in advance, before preparing the urethane prepolymer by adding the polyol (C) and MDI (D).

In contrast, in Comparative Example 7, the polyol (C) and MDI (D) were added simultaneously in the state in which the rosin ester (A′-2) was present to produce the urethane prepolymer, without adding only MDI (D) to prepare the urethane-modified rosin in advance. As a result, the rosin ester (A′-2) reacted with the isocyanate groups at the terminus of the urethane prepolymer, thus decreasing the yield of the urethane prepolymer containing isocyanate groups at the terminus. This caused large amounts of MDI (D) to remain in the moisture-curable hot melt adhesive, which is not environmentally friendly. Moreover, as is evident from Table 2, the Comparative Example 7 had inadequate initial cohesive force and heat resistance.

1. A moisture-curable hot melt adhesive containing an urethane prepolymer having an isocyanate group at the terminus, comprising:
a (A) urethane-modified rosin, and
a (B) copolymer of ethylene and a (meth)acrylic acid derivative,
wherein the urethane prepolymer is obtained by the reaction of polyol with an isocyanate compound.

2. The moisture-curable hot melt adhesive according to claim 1, wherein the (B) copolymer of ethylene and a (meth)acrylic acid derivative contains an ethylene-(meth)acrylic acid ester copolymer.

3. The moisture-curable hot melt adhesive according to claim 1, wherein the urethane prepolymer is obtained by the reaction of a polyol with an isocyanate compound, and the polyol contains an aromatic polyester polyol.

4. A method for producing a moisture-curable hot melt adhesive, which comprises:
(i) reacting an isocyanate compound with a rosin derivative having a hydroxyl group to obtain a (A) urethane-modified rosin, and
(ii) mixing the (A) urethane-modified rosin with (B) a copolymer of ethylene and a (meth)acrylic acid derivative.

5. The method for producing a moisture-curable hot melt adhesive according to claim 4, which comprises adding polyol with an isocyanate compound in the step (ii).
